(19) United States
(12) Patent Application Publication
(10) Pub. No.: US 2026/0259754 A1
(43) Pub. Date: Sep. 3, 2026

(54) EXTENDED DATA POOL FOR USER ASSISTANCE WHEN USING A MICROSCOPE

(71) Applicant: Carl Zeiss Microscopy GmbH, Jena (DE)

(72) Inventors: Sebastian SOYER, Munich (DE); Simon FRANCHINI, Munich (DE); Sandra LEMKE, Munich (DE); Emil NOWOSIELSKI, Wroclaw (PL); Jerzy KOWALSKI, Gdynia (PL); Tomaz BELCIJAN, Ljubljana (SI); Raphael DIAS-MONTEIRO, Paris (FR); Iosif SERAFEIMIDIS, Rostock (DE); Jasmina SMAILOVIC, Germering (DE)

(73) Assignee: Carl Zeiss Microscopy GmbH, Jena (DE)

(21) Appl. No.: 19/552,596

(22) Filed: Feb. 27, 2026

(30) Foreign Application Priority Data
Feb. 28, 2025 (DE) 102025107693.6

(51) Int. Cl. G06F 9/451; G02B 21/36; G06F 40/40

(52) U.S. Cl. CPC G06F 9/453; G02B 21/365; G06F 40/40

(57) ABSTRACT

Techniques in connection with providing user assistance when using a microscope are described. A machine-learned text model is used to provide user assistance information. In particular, techniques are described which make it possible to improve the quality of the user assistance information in a targeted manner by virtue of the fact that a database to which the machine-learned text model can have recourse is supplemented with elements.

### FIELD OF THE INVENTION

The present disclosure relates to techniques for providing user assistance when using a microscope. Various examples of the disclosure relate in particular to the use of a machine-learned text model for the generation of user assistance information associated with a microscope and/or a graphical user interface for the microscope control.

### BACKGROUND OF THE INVENTION

Microscopes are used in a multitude of applications, e.g. for imaging semiconductor samples, for imaging biological samples such as cells or tissues, for examining composite materials, for inline testing of a production line, for end-of-line testing of a production line, in science and manufacturing, etc. There are also a multitude of microscope types, including light microscopes, particle microscopes such as electron microscopes, helium ion microscopes, and atomic force microscopes. Even within a particular microscope type, there are a multitude of subtypes. For example, there are many different types of light microscopes, e.g. having different imaging modalities, different illumination configurations, different filters in the detection path, etc. Phase or amplitude imaging is possible. Fluorescence or light sheet imaging are further possibilities. Sometimes a single microscope can be controlled to provide many different modalities from among such imaging modalities, e.g. by activating or deactivating the use of specific optical filters in the imaging path, by using a specific illumination configuration, and/or by specific post-processing of the images. This variability between applications, coupled with the complexity of the hardware/software, makes it difficult to provide microscope users with tailored support. For example, a microscope manufacturer may be faced with the task of providing overly comprehensive user manuals covering all different types of applications and microscope hardware/software configurations. On the other hand, such complex manuals make it difficult for the user to find the specific information in which they are interested.

To address these problems, techniques are known for providing user assistance using a machine-learned text model. A prompt can be transferred to the machine-learned text model and the machine-learned text model can provide user assistance information for operating the microscope on the basis of the prompt. For example, a Copilot application may be implemented.

A machine-learned text model is a machine-learning model that has been trained on a large amount of data and is able to generate text and give a user human-like answers. For example, a Large Language Model (LLM) is a machine-learned text model that has been trained on the basis of a large amount of cross-domain text data, such as books, articles or web pages. LLMs known according to the prior art are based primarily on the knowledge in the data with which they were trained. To enable an LLM to accomplish domain-specific tasks that are not covered by its training data, it is possible to embed domain-specific context in the prompt. This technique is also known as Retrieval Augmented Generation (RAG). For RAG, context-sensitive information is retrieved from a database on the basis of a user request and is embedded in the prompt with the user request.

A major challenge is to fill the database with relevant domain-specific data for the use of a microscope and to keep the information up to date.

### SUMMARY OF THE INVENTION

Therefore, there is a need for a method which purposefully adds to a database such domain-specific information allowing the generation of appropriate user assistance information for the operation of a graphical user interface. In particular, there is a need for techniques which add such context information to the database with high quality and dynamically.

This problem is solved by a computer-implemented method for providing user assistance when using a microscope. The dependent claims define embodiments.

One aspect of the present disclosure relates to a computer-implemented method for providing user assistance when using a microscope. The computer-implemented method comprises providing a user with a graphical user interface, wherein the graphical user interface depicts microscope images captured by means of the microscope and enables the setting of a configuration of an imaging process for the microscope images. The method furthermore comprises generating a prompt for a large machine-learned text model, wherein the prompt enables the machine-learned text model to access one or more elements in a database associated with the microscope and/or the user interface. Moreover, the method comprises triggering an inference of the machine-learned text model on the basis of the prompt in order to obtain user assistance information for operating the user interface, and displaying the user assistance information. Furthermore, the method comprises determining whether the quality of the user assistance information satisfies one or more targets, upon displaying the user assistance information, and supplementing the database with a further element if the quality of the user assistance information does not satisfy said one or more targets.

A graphical user interface can relate to a visual interface that enables users to interact with an appropriate program via graphical interaction elements such as symbols, menus, and windows. The graphical user interface can display microscope images recorded by the microscope and can provide interaction elements for adapting imaging parameters or for configuration. For example, the graphical user interface can contain a configuration for setting exposure times, for selecting filters, or for activating specific imaging methods. As an alternative or in addition to such hardware settings, the interaction elements of the graphical user interface can enable the setting of one or more software post-processing steps that are applied to the recorded images. Setting a configuration of an imaging program can be for example a processing method, such as blur compensation, noise reduction, or image segmentation.

A microscope image can be a visual representation of a sample recorded using a microscope. Such microscope images can be generated by various imaging methods, such as brightfield microscopy, fluorescence microscopy, phase contrast microscopy or other embodiments depending on the type of microscope. The microscope image can be displayed in real time during the recording process or stored for later analysis.

A microscope can be a light microscope or a particle microscope. A microscope can be a scanning electron microscope. Transmission or reflection microscopy can be used. The techniques disclosed herein can be applied to various kinds and types of devices that provide microscopic images.

The machine-learned text model is a machine-learning model that has been trained on a large amount of data and is able to give a user human-like answers. In particular, the text model can be trained on a training data set that is not limited to information in connection with microscopes or microscopy. For example, the machine-learned text model can be a text-to-text model. For example, the text model can comprise a transformer architecture. A sequence of tokens is analysed and correlations are detected. A subsequent token is then predicted. For example, the machine-learned text model can comprise an LLM. The LLM can be trained using unsupervised learning methods such as Masked Language Modelling or Next Sentence Prediction. The LLM can have a deep neural network that provides a sequence-to-sequence prediction. For example, the LLM can have self-attention layers. Such techniques enable the machine-learned text model to learn general language patterns and relationships that are not specific to a specific area or specific task. Therefore, the machine-learned text model can be regarded as a non-domain-specific model, i.e. it is not limited to a specific application or a specific use case. The text model can be adapted to a multiplicity of tasks, for example by means of suitable prompting. Prompting involves issuing a specific request to the text model, which is then processed.

For example, the database can comprise a structured vector database. The database can form the data pool for RAG techniques. The database can include coded representations of domain-specific information elements, i.e. context information for the microscope and/or the graphical user interface. For example, the structured database information can be microscopy-specific. The domain-specific information can comprise information that has not been used to train the machine-learned text model. The elements of the database can comprise for example a log file of the microscope or pairs of prompts and associated user assistance information. This means that the database can serve as a data pool for generating the user assistance information.

In the context of the method, a query is issued to the structured database for example on the basis of a request for user assistance from the user. The structured database thereupon provides said one or more elements with information appropriate to the database query. Particularly relevant information elements can be determined for example by the query being vectorized, that is to say mapped into a latent feature space that also includes the coded information in the database. In this way, a feature vector for the query is thus obtained. Those elements in the database which are at the smallest distance from the feature vector of the query are then identified. Various distance metrics can be used, for example the Euclidean distance between two corresponding feature vectors. The vectors obtained from the database in this way are then embedded in the prompt, for example. This enables the prompt to be adapted to the specific user question.

In one example, the computer-implemented method comprises obtaining a user request, selecting said one or more elements from a multiplicity of candidate elements stored in the structured database, on the basis of the user request, and embedding said one or more elements in the prompt. RAG techniques can thus be executed.

In other examples, an execution environment for the machine-learned text model can enable independent access to the database. In that case, it is not necessary to embed the corresponding information in the prompt in order to enable the machine-learned text model to access the information queried from the database.

For example, the prompt for the machine-learned text model can comprise a user question (in text form) and said one or more elements from the structured database. For example, the prompt can be a question from the user about a change in the system setting and associated information from the structured database. For example, if the user would like to change the image noise of the microscope images and asks this question pertaining to user assistance, information about image noise setting changes can be queried from the structured database. Using the information from the structured database information together with the user's question, a prompt can be created and transferred to the machine-learned text model. Inference on the part of the latter then takes place on the basis of the prompt. In a further example, a previous question-answer pair from the structured database can be added to the prompt, said pair relating to changes in the image noise setting. This can improve the quality of the user assistance answer, since the machine-learned text model obtains domain-specific information to generate an answer.

Inference denotes a process in which a trained model is used to make predictions or decisions on the basis of new and unknown data. An inference can be for example the classification of an object, the prediction of a value, or the grouping of similar objects into a class. In the present disclosure, an inference of the machine-learned text model is triggered on the basis of a prompt in order to obtain user assistance information for operating the user interface. The prompt for the machine-learned text model comprises said one or more elements from a structured database associated with the microscope and/or the user interface. This has the effect that the machine-learned text model obtains domain-specific information and can adequately answer the user request. This can improve the quality of the user assistance information and facilitate the operation of the user interface.

For example, the user assistance information can comprise indications for operating the graphical user interface. The user assistance information can comprise specific instructions to the user as to which interaction elements to actuate or which settings to make. For example, the user assistance information can display a sequence of operating steps. For example, the user assistance information can comprise general indications about microscopy. For example, the user assistance information can provide the user with context information about microscopy, for example regarding different imaging modalities or microscope types. For example, background information about phase contrast imaging or transmitted light microscopy could be provided.

Upon displaying the user assistance information, it is possible to ascertain whether the quality of the user information satisfies said one or more targets. There are various ways to determine whether the quality of the user information satisfies one or more targets. For example, there can be explicit feedback from the user. This means that the user can explicitly assess the quality. However, implicit feedback would also be conceivable. One example of this would be a sentiment analysis of the conversation. Here, the user's wording is used to deduce their state of mind and thus to assess whether the question has been answered satisfactorily. Some examples are discussed below. In one example, a target cannot be satisfied if the user does not follow the instruction of the user assistance information upon the user assistance information has been displayed. Furthermore, the user can assess the user assistance information by way of feedback. For example, the user feedback can be a star rating or an answer to the user assistance question. For example, the user assistance can ask the user if they were satisfied with the user assistance information, and the user can answer Yes or No. If the user answers No, for example, the quality of the user assistance information does not satisfy the target. In another example, the star rating by the user of the user assistance information may comprise less than three stars, and hence not satisfy the target. Further forms of a feedback mechanism are also conceivable.

In the present disclosure, the structured database is supplemented by one or more elements if the quality of the user assistance information does not satisfy said one or more targets. In this way, therefore, the data pool that the machine-learned text model can access is purposefully extended if an unsatisfactory quality of the user assistance information generated by means of the machine-learned text model has been recognized. If the target is not satisfied, the user assistance information with associated prompt can be transferred for example to a domain expert for evaluation. The domain expert can thereupon create improved user assistance information and transfer the improved user assistance information with associated prompt to the structured database. As a result, the structured database is filled with domain-specific knowledge and the data pool is extended. Besides such manual creation of further elements for the structured database, it would also be conceivable to create elements for the structured database by means of an implicit mechanism, so that manual expert annotation is not necessary. For example, it would be possible to check how the user operates the graphical user interface upon the user assistance information has been displayed, and to ascertain on the basis of such monitoring what actual user interactions with the user interface achieved the desired result. Then, on the basis of this, it is possible to create a corresponding element for the structured database.

One effect of the present disclosure is that the database is equipped with high-quality domain-specific knowledge. In this way, the data pool to which the machine-learned text model can have recourse for providing the domain-specific assistance information is gradually extended. As a result, the quality of the user assistance information will become better and better over time or can adaptively conform to specific developments for example in the graphical user interface and/or in the case of a microscope.

Various examples are based in particular on the insight that the improvement of "negative examples", in which the user assistance information does not satisfy said one or more quality targets, enables a particularly strong improvement of the prediction quality for the user assistance information by means of the machine-learned text model. For example, by recognizing such negative examples, it is possible to identify specific areas of the user requests for which there is not yet a sufficient data pool available in the database, so that the user assistance information predicted by machine-learned text model; owing to the data pool shortfall, the user assistance information would be of inferior quality without the corresponding supplementation of the database. This means that, in particular, an "exploration" approach to extending the data pool can be fostered. The learning curve for improving the user assistance information is thus particularly steep, while at the same time the required annotation effort is limited.

A further effect is that the database is able to be automatically extended without the need for technical experts to be consulted on site. For example, domain experts assigned to a central authority can refine the system gradually and independently of the specific user assistance incident. Domain-specific knowledge can improve the quality of user assistance information and the quality of user assistance. A further advantageous effect is that the feedback mechanism can be integrated into a production environment in order to make the domain expert aware of questions that have not yet been adequately answered. Since users can provide real-time feedback on the answers received from the user assistance, this input from the user can serve as a valuable signal for the domain expert. As a result, the domain expert can concentrate their efforts on the gaps in the system, iteratively refine the knowledge base of the structured database and thus improve the performance of the system and ensure that it evolves in accordance with the users’ needs.

In the various examples described herein, it is possible for a kind of "distributed learning" to be made possible by the techniques described herein. For example, information on whether or not the quality of the user assistance information satisfies one or more targets can be collected on a large number of distributed instances of the graphical user interface. The user assistance information and, if appropriate, a corresponding request by the user for the user assistance information can be anonymized and used without sensitive content (such as the microscope images themselves) to improve the coverage of the structured database. This ensures that many distributed users contribute to improving the scope and content of the structured database.

In a further embodiment, the further element by which the structured database is supplemented comprises the prompt and a ground truth associated with the prompt. For example, the ground truth can be provided by the domain expert (who is different from the user who uses the graphical user interface) or created on the basis of monitoring the user interaction with the graphical user interface. This improves the knowledge base of the structured database. Targets for input-output pairs are created which can serve as a basis for the machine-learned text model. On the basis of the improved knowledge base of the structured database, the machine-learned text model can generate improved user assistance information for the user interface condition.

The method can furthermore comprise monitoring a user interaction with the graphical user interface upon displaying the user assistance information, and generating a ground truth on the basis of monitoring the user interaction. Monitoring the user interaction can comprise which user interface elements of the graphical user interface are activated or deactivated, which setting of the imaging process is changed, and/or which microscope image of a plurality of microscope images associated with different settings of the imaging method is stored by the user. Monitoring the user interaction makes it possible to ascertain whether the user indications of the user assistance information are followed by the user. Not only does this provide information about whether the user assistance information was helpful to the user, it also enables the ground truth to be determined on the basis of such monitoring of the user interaction. For example, the user might raise a request regarding how it is possible to segment only dead cells into a microscope image that was captured without fluorescence contrast. The machine-learned text model can then generate a proposal for solving this problem as user assistance information and this user assistance information can be displayed. The user might then try out this solution approach and ascertain that this solution approach does not achieve the desired success, that is to say that it is not possible to segment only dead cells for example purely by adapting the digital image evaluation. The user subsequently ascertains that using a digital phase contrast makes it possible to generate microscope images that enable the desired segmentation. In this respect, the user adapts the illumination of the sample object in order to obtain the digital phase contrast, and additionally adapts the digital image evaluation via the graphical user interface. This is determined in the context of appropriate monitoring and a "recipe” for answering the user's initial question is derived therefrom. This can then be assumed to be ground truth and the operated database can be supplemented with a corresponding element. For example, a value pair comprising the corresponding user request and/or the prompt and also the ground truth could be stored. It is clear from the example above that it is possible to generate the ground truth without manual annotation. This makes it possible to generate the ground truths for a large number of user requests without time-consuming manual annotating. Rather, the user themself generates the ground truth, sometimes also referred to as "pseudo-label": the reliability of such a ground truth generated by the user themself may be high enough – in absolute terms – to include a speaking element in the structured database; at the same time, the reliability of such a ground truth generated by the user themself may be lower than the reliability of a comparable ground truth generated by a domain expert.

The computer-implemented method for example furthermore comprises obtaining expert feedback on the prompt, wherein the ground truth for the user assistance information comprises the expert feedback. For example, the prompt can be sent to a domain expert, for example over the Internet. The domain expert can assess the prompt and create further user assistance information as ground truth. The domain expert can be part of a central authority. For example, the domain expert might work for a manufacturer of the graphical user interface and/or microscope. In particular, the domain expert can be located outside the local network, so that the prompt is sent over the Internet, for example, in order to obtain the expert feedback. By comparing the prompt and the user assistance information and/or the user feedback on the user assistance information, the domain expert can ascertain whether the user assistance information was helpful to the user. In addition, the domain expert can create improved user assistance information on the basis of their expert knowledge. The user assistance information created by the expert can be transferred to the structured database together with the prompt. This has the effect that the database is extended without the need for technical experts to be consulted directly on site. Domain experts can work "remotely", i.e. away from the microscope. Domain experts can belong to a different organization than the user of the microscope. Domain experts can refine the system gradually and temporally independently of the arising of the user assistance information by using their specialist knowledge – without having to intervene technically in the specific case. This enables the system to be gradually improved centrally in accordance with the user’s needs.

In one example, the method furthermore comprises generating an entry in a work list for the domain expert, wherein the entry comprises the prompt and optionally the user assistance information and/or user feedback on the user assistance information, wherein the expert feedback is associated with the entry in the work list. This makes it possible to collect candidate prompts for which an associated ground truth would be helpful. The domain expert can work both spatially and temporally independently of the users of the graphical user interface. The domain expert can thus specifically identify such user requests for which the provision of corresponding ground truths is particularly expedient, for example because it would encompass areas previously covered by the structured database or enables a steep learning curve for the quality of the user assistance information provided by the machine-learned text model.

In a further example, the computer-implemented method comprises, upon displaying the user assistance information, monitoring a user interaction with the graphical user interface, wherein, on the basis of monitoring the user interaction, it is determined whether the quality of the user assistance information satisfies said one or more targets. For example, monitoring the user interaction can comprise recognizing a change in the setting of an interaction element of the graphical user interface. For example, said one or more targets can comprise following an instruction of the user assistance information. For example, if the user does not follow the user assistance information, the quality of the user assistance information does not satisfy the targets. This has the effect that feedback about the user assistance information is implicitly obtained. The user does not need to give explicit feedback on the quality of the user assistance information. Rather, it is automatically determined whether the quality of the user assistance information was sufficient or whether the user assistance information enabled the user to achieve the desired result. This makes it possible to obtain more comprehensive feedback on the quality of the user assistance information than is typically possible in the case of manual obtaining of feedback.

In a further embodiment, the computer-implemented method comprises obtaining user feedback for the user assistance information, wherein, on the basis of monitoring the user feedback, it is determined whether the quality of the user assistance information satisfies said one of the plurality of targets. In particular, explicit user feedback can be obtained. The user feedback can be a thumbs up or down, for example, which allows the user to express whether they are satisfied with the user assistance information. A star rating can be requested. For example, one target may be that the user feedback must be positive. If the user feedback is negative, for example by virtue of the user choosing a thumbs down, the quality of the user assistance information does not satisfy the target. As a result, the user has the option to directly assess the user assistance information. In a further example, the user feedback can comprise a star rating or other rating systems. By monitoring the user feedback, the system obtains information about the quality of the user assistance information.

In a further example, the user assistance information comprises one or more operating indications for the graphical user interface. For example, an operating indication may be that a setting of the configuration of the imaging process ought to be changed. There are various possibilities for implementing the user assistance information. For example, it is possible to provide a tutorial-guided work sequence for the user interaction. The tutorial/guided work sequence can relate to the user interaction with the graphical user interface. For example, a step-by-step guide can be made available to the user regarding which user interface interaction elements need to be activated or dealt with and/or which settings are required in order to achieve a specific goal. For example, the user assistance information can index an order of the interaction elements of the graphical user interface that are to be actuated. For example, the user assistance information can index the position of the interaction elements of the graphical user interface that are to be actuated. What can be achieved by means of such user assistance information is that the user is purposefully instructed to operate the graphical user interface.

In a further example, the method comprises a ground truth for the user assistance information which is at least partly different from the user assistance information. Such a technique is expedient especially if it is ascertained that the quality of the user assistance information has not satisfied said one or more targets. In that case, it is not the qualitatively improvable user assistance information that is stored in the structured database; rather, it is the ground truth whose quality satisfies said one or more targets. In this way it is possible to achieve a curated quality for the elements in the structured database.

Furthermore, said one or more elements of the structured database comprise specified pairs of prompts and associated user assistance information. Provision of such an input-output pair enables the machine-learned text model to better determine possible outputs for future prompts, for example by considering as template such input-output pairs which have an input that is finite with respect to the future prompt.

However, it is not necessary in all variants to enhance the structured database with nominal input-output pairs. Rather, it could also be recognized that specific sources of information helpful for an accurately targeted determination of the user assistance information are missing in the structured database. Such sources of information need not relate to specific user requests for user assistance, but rather can comprise generally knowledge regarding the microscope used or regarding the graphical user interface. Since the machine-learned text model can have an ability for logical reasoning, an extended data pool for a better quality of the user assistance information can also be achieved on the basis of such general information in the future. In this regard, in a further example, said one or more elements in the structured database comprise one or more items of information of a log file of the microscope, one or more items of information of a description of a current hardware configuration of the microscope, one or more items of information of a description of a current configuration of the graphical user interface, one or more items of information of an operating manual of the microscope, one or more items of information of an operating manual of the graphical user interface, or information about the user of the microscope and the graphical user interface.

In a further embodiment, the graphical user interface is provided by means of a first electronic data processing device, wherein the inference of the machine-learned text model is triggered by means of a second electronic data processing device, which is encapsulated by the first electronic data processing device. For example, the provision of the graphical user interface is executed in an encapsulated operating system. For example, a control unit comprising a processor and a memory for storing program code for executing the graphical user interface can be situated in a local network that is not connected to the Internet.

For example, the machine-learned text model can be executed on a central server (cloud deployment). The second electronic data processing device can then request the inference of the machine-learned text model from the server via the Internet. It would also be conceivable for the machine-learned text model to be executed locally on the second electronic data processing device. The second electronic data processing device can provide a further graphical user interface, wherein the user assistance information is displayed by means of the further graphical user interface. For example, the second electronic data processing device can be integrated in a smartphone or a laptop. Encapsulation of the operating system on the first electronic data processing device, for example without access to the Internet, can provide an increased security for the microscope images and examined samples. At the same time, the user assistance information can be provided purposefully by the use of the separate, second electronic data processing device. In some examples, it would be conceivable to implement a secure local communication link between the first electronic data processing device and the second electronic data processing device. This secure communication link can make it possible for example to transfer specific information elements that are not security-relevant and/or are anonymized. For example, it would be conceivable for such information elements to be transferred only upon user approval. For example, by means of such information elements, it may be possible to transfer user feedback on the quality of the user assistance information from the first electronic data processing device – on which the graphical user interface for controlling the microscope is executed – to the second electronic data processing device – which for example is connected to the Internet.

The first electronic data processing device can be a computer, for example, and the second electronic data processing device a smartphone. The computer provides the graphical user interface that displays the microscope images to the user. For example, the user can ask user assistance a question about an exposure time setting of the microscope images by means of an app on the smartphone. On the basis of the user's question, the app queries the structured database, which selects from a plurality of candidate elements and then embeds them in the prompt. For example, the plurality of candidate elements can be vectors similar to one another. The app sends the prompt to the machine-learned text model, for example an LLM, and triggers the inference. However, the query of the database and the supplementation of the prompt with corresponding information can also be effected in a cloud-based manner.

The features set out above and features described below can be used not only in the corresponding combinations explicitly set out, but also in further combinations or in isolation, without departing from the scope of protection of the present disclosure.

### BRIEF DESCRIPTION OF THE DRAWINGS

FIG. 1 schematically shows a user, a microscope, and a control unit connected to a machine-learned text model and a database.

FIG. 2 schematically shows a user, a microscope, a control unit, and a further control unit connected to a machine-learned text model and a database.

FIG. 3 illustrates an exemplary application in accordance with one embodiment.

FIG. 4 schematically shows a signal flowchart of a computer-implemented method according to one embodiment.

FIG. 5 is a flowchart of one exemplary method.

### DETAILED DESCRIPTION OF THE INVENTION

The above-described properties, features and advantages of this disclosure and the way in which they are achieved will become clearer and more clearly understood in association with the following description of the exemplary embodiments which are explained in greater detail in association with the drawings.

The present disclosure is explained in greater detail below on the basis of preferred embodiments with reference to the drawings. In the figures, identical reference signs designate identical or similar elements. The figures are schematic representations of various embodiments of the disclosure. Elements illustrated in the figures are not necessarily illustrated as true to scale. Rather, the various elements illustrated in the figures are rendered in such a way that their function and general purpose become comprehensible to a person skilled in the art. Connections and couplings between functional units and elements illustrated in the figures can also be implemented as an indirect connection or coupling. A connection or coupling can be implemented in a wired or wireless manner. Functional units can be implemented as hardware, software or a combination of hardware and software.

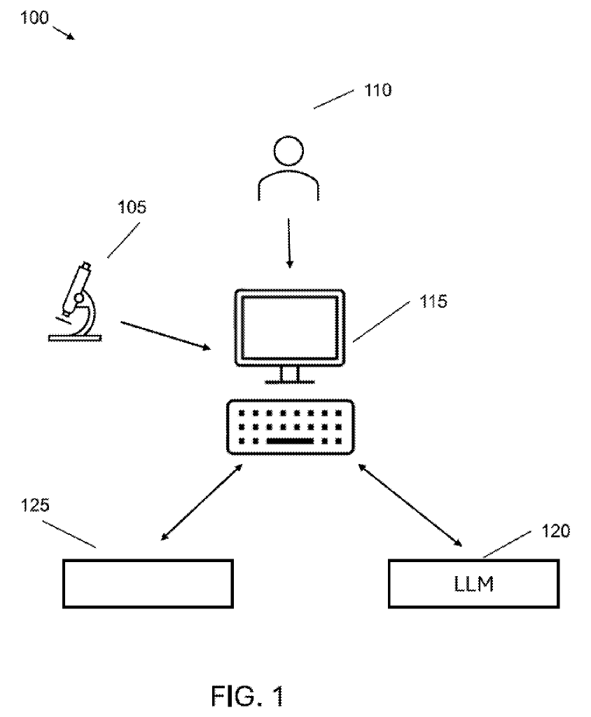

FIG. 1 schematically shows a system 100 comprising a digital microscope 105 with a camera chip. The microscope 105 records one or more microscope images and sends same to a control unit 115.

The control unit 115 implements a graphical user interface, which enables the capture of images, the display of the microscope images and/or the digital post-processing of captured raw image data.

The microscope images can be generated by various imaging methods such as fluorescence microscopy. A captured microscope image can be displayed in real time to a user 110 during the recording process or stored for later analysis and/or digital post-processing.

For example, the control unit 115 can have a processor and a memory, wherein the processor can load program code from the memory and execute it. When the processor executes the program code, this causes the processor to obtain and/or request program code from the microscope 105. It would also be conceivable for the processor to change specific settings of the microscope 105. The control unit 115 can also be referred to as an electronic data processing device.

The control unit 115 provides the graphical user interface on the basis of the program code, with which graphical user interface the user 110 can interact. The graphical user interface displays the microscope images from the microscope 105 to the user 110. Furthermore, the control unit 115 enables the setting of a configuration of an imaging process for the microscope images by means of the graphical user interface. Setting a configuration of an imaging process can comprise for example storing or manipulating the microscope images or, in addition, setting one or more software post-processing steps. In general, the graphical user interface can comprise a plurality of interaction elements, via which specific settings of the microscope and/or of the processing of microscope images can be effected.

In addition, the user 110 can operate a user assistance module via the graphical user interface. The user assistance module can implement a chatbot, for example, with which the user 110 can communicate via text input. The user 110 can make user requests for user assistance in this way. For example, a specific question can be formulated, such as a question about a configuration of the imaging process of the microscope images. User assistance information of the user assistance can be displayed to the user 110 via the graphical user interface of the control unit 115.

The control unit 115 is connected by communication link to an execution environment that executes a large machine-learned text model 120. It would be conceivable for the machine-learned text model 120 to be executed in a local environment of the control unit 115, so that the latter communicates with the execution environment via a local network, for example. However, it would also be possible for the execution environment for the machine-learned text model 120 to be located on a server that is connected to the control unit 115 via the Internet.

In FIG. 1, the machine-learned text model 120 comprises an LLM. However, the large machine-learned text model 120 can alternatively or additionally also comprise other text models, assisting program routines, etc.

The control unit 115 is connected by communication link to a database 125, for example via the Internet. It would be conceivable for the structured database 125 to be located in a local environment of the control unit 115, so that this communicates with the database 125 via a local network, for example. For example, the database 125 can be a vector database.

When user assistance is requested (for instance explicitly by the user or implicitly, for instance by user interaction with the graphical user interface), a prompt is generated for the LLM 120.

On the basis of a request for user assistance, a query of the structured database 125 is performed. The structured database 125 returns one or more elements similar to the context of the user assistance request. Said one or more elements can then be embedded in the prompt. In this way, the prompt enables the machine-learned text model to access said one or more elements in the structured database 125 associated with the microscope and/or the user interface.

While FIG. 1 shows a scenario in which the query to the database 125 is executed directly by the control unit 115, the query of the database 125 could also be performed by a cloud-based server, on the basis of a corresponding request to the server by the control unit 115. For example, the cloud-based server can then supplement a corresponding prompt to the machine-learned text model 120 on the basis of a result of the database query.

On the basis of the prompt, an inference of the LLM 120 is triggered in order to obtain user assistance information for operating the graphical user interface of the control unit 115.

For example, it is possible to display the user assistance information to the user 110 via the graphical user interface or in particular the user assistance module. For example, the user assistance information can be operating indications for the configuration of the imaging process. For example, the user assistance information can instruct the user to activate or deactivate an optical or digital filter. The user assistance information can comprise for example a sequence of elements of the graphical user interface that are to be clicked or otherwise actuated. For example, the user assistance information can be implemented as a graphical highlighting of an interaction element or as a tooltip pop-up associated with an interaction element. Such a tooltip pop-up can contain a textual description of a functionality of this interaction element.

The graphical user interface of the control unit 115 can monitor the user interaction of the user 110 of the graphical user interface upon displaying the user assistance information. Monitoring the user interaction can comprise for example which interaction elements of the graphical user interface are activated or deactivated by the user 110, or which settings of the imaging process are effected, or which microscope image of a plurality of microscope images associated with different settings of the imaging process is stored by the user. Implicit feedback about the user assistance information can be obtained by way of the monitoring. For example, if the user 110 follows the user assistance information instruction to store an image, that may indicate that the user assistance information was helpful.

Upon displaying the user assistance information, it is however also possible to ascertain in some other way whether the quality of the user assistance information satisfies one or more targets. For example, explicit user feedback on the user assistance information could be obtained. For example, the user could allocate a star rating or a thumbs up/down rating. This query can be effected by way of the user assistance module.

If the quality of the user assistance information does not satisfy said one of the plurality of targets, the structured database 125 can be supplemented by one or more further elements. For example, the further element can be a specified pair of prompt and associated user assistance information. However, other elements could alternatively or additionally also be added, for example information of a log file of the microscope 105, a description of a current hardware configuration of the microscope 105, a description of a current configuration of the graphical user interface, an operating manual of the microscope 105, information about the user 110 of the microscope 105 of the graphical user interface, etc.

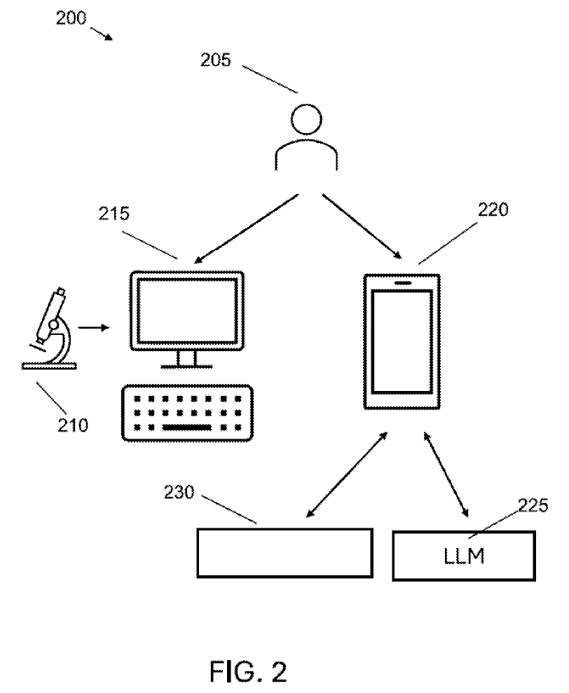

The disclosure above concerned a sequence for generating a prompt for a large machine-learned text model, triggering the inference, displaying user assistance information, and supplementing a structured database with elements if the quality of the user assistance information does not satisfy specific criteria or targets. Such a sequence can be executed for example by the system 100 in accordance with FIG. 1. However, implementations different from those in FIG. 1 would also be possible for implementing a corresponding sequence. One example is shown in FIG. 2.

FIG. 2 schematically shows a further system 200, wherein there – unlike in FIG. 1 – a further control unit 220 is connected by communication link to an execution environment of an LLM 225. The further control unit 220 can be implemented for example on a smartphone or a PC. The further control unit 220 is also connected by communication link to the structured database 230. In FIG. 2, the microscope images from the microscope 210 are sent to the control unit 215. The control unit 215 – like the control unit 115 – provides the graphical user interface. The user can make a request for user assistance via the control unit 220; for this the latter can implement a corresponding graphical user interface with a user assistance module.

As already described in FIG. 1, afterwards the structured database 230 is queried and, on the basis of the information of the structured database and the request of the user 205, a prompt is created, the prompt is transferred to the LLM 225 and an inference is triggered. On the basis of the feedback from the LLM 225, user assistance information is displayed to the user via the control unit 220. User feedback on the user assistance information can be obtained via a graphical user interface provided by the control unit 220.

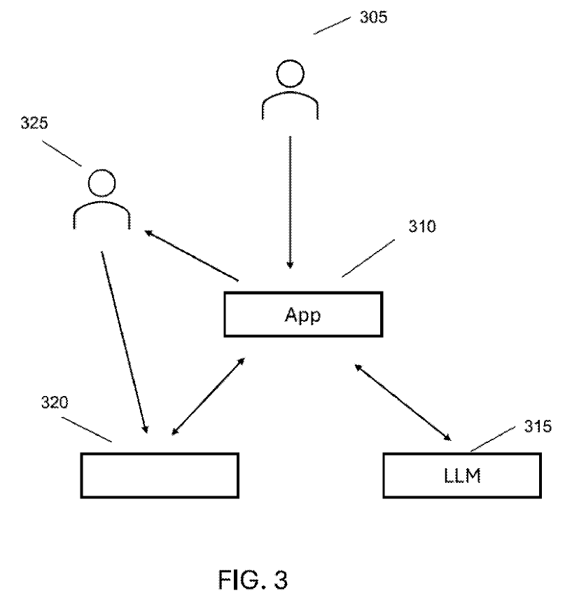

FIG. 3 shows an application 310 executed on a control unit such as the control unit 220 or the control unit 115. The user 305 makes a request for user assistance by means of an input into the application 310. The application 310 provides a user assistance module.

On the basis of the input, a prompt is generated for the machine-learned text model 315. The prompt can include for example a question from the user and/or further context information about the graphical user interface of the microscope or about the microscope. The prompt can additionally enable the LLM 315 to access one or more elements of the structured database 320.

On the basis of the prompt, the LLM 315 creates user assistance information. The information from the structured database 320 enables the LLM 315 to create domain-specific user assistance information. The structured database 320 extends the data pool of the LLM 315 by comparison with the training data.

The user assistance information can be displayed to the user 305 via the application 310. In addition, the user 305 can rate the user assistance information by means of the application 310. For example, the rating can be on the basis of a rating system of one to five stars. This makes it possible to ascertain whether the quality of the user assistance information satisfies specific targets.

If the quality of the user assistance information does not satisfy one or more targets in respect of its quality, then the prompt that was transferred to the LLM 315 and/or the user assistance information obtained by the LLM 315 can be transmitted from the application 310 to a domain expert 325, for example. The domain expert 325 can thereupon create alternative user assistance information and/or identify further information elements that enable better user assistance information. Such information elements can be transferred – for example together with the prompt – to the structured database 320. This has the effect that the structured database 320 is extended with domain-specific knowledge about specific use cases of the user 305 and the user assistance information generated by the LLM 315 is improved because the LLM 315 can access an extended data pool.

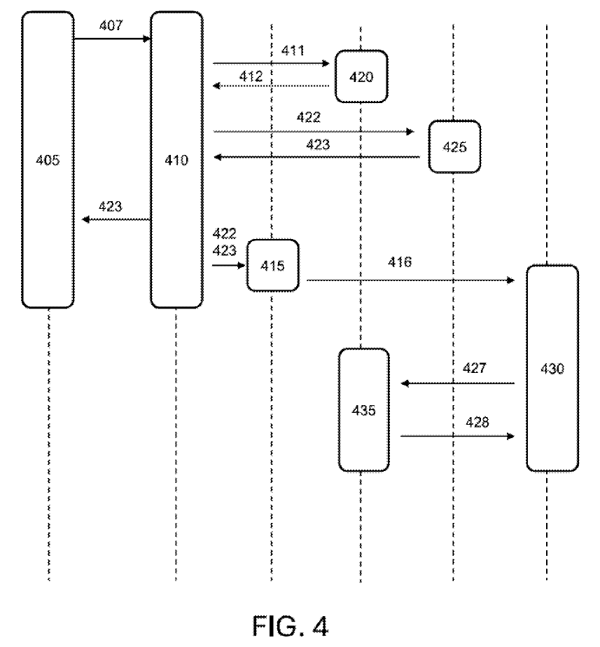

FIG. 4 shows a signal flowchart of one exemplary method. A user 405 sends a request 407 for user assistance information to the application 410 (cf. application 310).

For example, such a request 407 could include a specific question in text form, for example how a specific post-processing of microscope images can be set or how the image capture can be adapted.

The application 410 performs a query 411 of the structured database 420 on the basis of the request 407. The structured database 420 returns information 412 to the application 410. In this case, the information 412 comprises for example coded feature vectors which are most similar to a latent representation of the request 407. This enables particularly relevant information elements to be loaded from the structured database 420. For example, the information 412 can contain a plurality of question-answer pairs. For example, the information 412 can comprise specific log files, operating instructions, etc.

The request 407 from the user 405 is combined together with the information 412 to form a common prompt. This prompt 422 is transferred to the LLM 425. On the basis of the prompt 422, the LLM 425 creates user assistance information 412 and transfers the user assistance information 423 to the application 410.

The application 410 displays the user assistance information 423 to the user 405.

Depending on the quality of the user assistance information, the prompt 422 and the user assistance information 423 are then transferred to a module 415. The module 415 can anonymize and/or supplement this information.

Corresponding information 415 is then transferred to a domain expert 430. The domain expert 430 then creates one or more elements 427 that are included in the structured database 420. The latter can provide a confirmation 428.

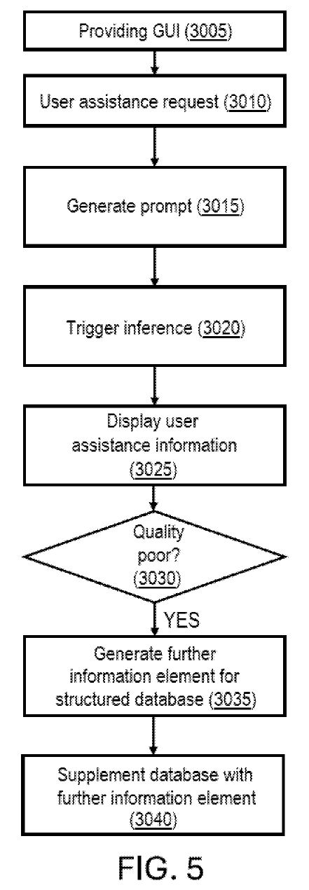

FIG. 5 is a flowchart of one exemplary computer-implemented method. The method from FIG. 5 can be executed by one or more electronic data processing devices such as the control unit 115 and/or the control unit 215 and the control unit 220 (cf. FIGS. 1 and 2). The method from FIG. 5 can be executed by a processor when the latter loads program code from a memory and executes it.

In step 3005, a graphical user interface is provided. Corresponding aspects have been described above in connection with a graphical user interface for the microscope 105 and respectively the microscope 210.

In step 3010, a request for user assistance is obtained. For example, a user could explicitly request assistance, for instance by inputting a corresponding question into a text form. However, the request for user assistance could also be obtained implicitly, for example by virtue of the fact that monitoring the user interaction with the graphical user interface provided in step 3005 reveals that the user cannot accomplish specific tasks or repeatedly presses specific buttons.

The request for user assistance can define a specific type of task.

In step 3015, a prompt is then generated for a large machine-learned text model. The prompt enables the machine-learned text model to access one or more elements in a structured database. The structured database is associated with the microscope and/or the graphical user interface, that is to say that the structured database has elements that include context information about the microscope and/or about the graphical user interface. Access to such elements can be effected by means of RAG techniques. In particular, coded representations of elements in the structured database could be embedded in the corresponding prompt, for instance on a local computer or by means of a cloud server. Alternatively or additionally, the prompt can also include an instruction for the machine-learned text model to perform corresponding access to the structured database.

In step 3020, the inference of the machine-learned text model is then executed on the basis of the prompt. The machine-learned text model can be executed in a local application environment or on a server. In this way, user assistance information is obtained.

The user assistance information is then displayed in step 3025, for example in the context of the graphical user interface or else via a different, further graphical user interface (a corresponding scenario has been discussed above in association with FIG. 2).

Upon the user assistance information has been displayed in step 3025, subsequently step 3030 involves checking whether the quality of the user assistance information satisfies one or more targets. There are various possibilities for carrying out an assessment of the quality in step 3030. For example, explicit user feedback could be obtained. It would also be possible to monitor the user interaction of the user with the graphical user interface upon the user assistance information has been displayed; it is possible to check whether the user follows or deviates from any instructions as included in the user assistance information. Alternatively or additionally, a check could be made to establish whether the implementation of specific instructions included in the user assistance information accomplishes the type of task formulated in the user assistance request in step 3010.

If the quality of the user assistance information does not satisfy said one or more targets, step 3035 is executed. In step 3035, one or more further elements are generated for the structured database, and the structured database is supplemented therewith in step 3040. One or more additional information elements for the structured database can be generated for example fully automatically, partially automatically or manually in step 3035. For example, an expert annotation could be obtained from a domain expert, as discussed above in association with FIG. 4. However, a pseudo-ground truth could also be obtained by monitoring the user activity.

It goes without saying that the features of the embodiments and aspects of the invention described above can be combined with one another. In particular, the features can be used not only in the combinations described but also in other combinations or on their own, without departing from the scope of the invention.

For illustration purposes, various examples have been described in connection with a single LLM. In some scenarios, the task for providing user assistance information can be subdivided into a plurality of subtasks, and the plurality of subtasks can be executed by different LLMs. A multi-agent system is also conceivable, in which multiple LLMs work together to accomplish a specific task for providing user assistance information. A multi-agent system is an architectural framework in which multiple agents interact and work together to achieve a common goal. Such systems are particularly useful if the tasks in question can be broken down into sub-tasks that can be allocated to different agents, each having different skills or expertise. For example, one agent may specialize in natural language processing, while another agent specializes in retrieving technical documentation or operating system logs. Each agent in a multi-agent system can work with different degrees of autonomy, ranging from tightly coupled collaboration to loosely coordinated interaction.

For further illustration: While various examples have been disclosed in connection with light microscopy, similar techniques can be applied for example to scanning particle microscopes, e.g. scanning electron microscopes. Still other kinds of microscope are conceivable as well, e.g. atomic force microscopes.

For further illustration, various examples have been disclosed in connection with a graphical user interface for controlling a microscope. However, similar techniques can also be applied to other machines, for example to volumetric imaging tools such as computed tomography machines, magnetic resonance imaging machines, lithography apparatuses, micromanipulators, to name just a few examples.

What is claimed is:

1. A computer-implemented method for providing user assistance when using a microscope, wherein the method comprises:
providing a user with a graphical user interface, wherein the graphical user interface is configured to depict microscope images captured by means of the microscope and to enable a setting of a configuration of an imaging process for the microscope images,
generating a prompt for a machine-learned text model, wherein the generated prompt enables the machine-learned text model to access one or more elements in a database associated with the microscope and/or the user interface,
triggering an inference of the machine-learned text model on a basis of the generated prompt in order to obtain user assistance information for operating the graphical user interface,
displaying the user assistance information,
upon the displaying of the user assistance information, determining whether a quality of the user assistance information satisfies one or more targets, and
if the quality of the user assistance information does not satisfy said one or more targets: supplementing the database with a further element.

2. The computer-implemented method according to claim 1,
wherein the further element comprises the generated prompt and a ground truth associated with the generated prompt.

3. The computer-implemented method according to claim 2, wherein the method furthermore comprises:
upon displaying the user assistance information: monitoring a user interaction with the graphical user interface, and
generating the ground truth on a basis of the monitoring of the user interaction.

4. The computer-implemented method according to claim 3,
wherein the monitoring of the user interaction comprises:
monitoring which user interface elements of the graphical user interface are activated or deactivated;
monitoring which settings of the imaging process are changed;
monitoring which microscope image of a plurality of the microscope images associated with different settings of the imaging process is stored by the user; or
any combination thereof.

5. The computer-implemented method according to claim 2, further comprising:
obtaining expert feedback on the generate prompt,
wherein the ground truth for the user assistance information comprises the expert feedback.

6. The computer-implemented method according to claim 5, further comprising:
generating an entry in a work list for a domain expert, wherein the entry comprises the generated prompt and optionally the user assistance information and/or user feedback on the user assistance information,
wherein the expert feedback is associated with the entry in the work list.

7. The computer-implemented method according to claim 1, wherein the method furthermore comprises:
upon displaying the user assistance information: monitoring a user interaction with the graphical user interface,
wherein, on a basis of the monitoring of the user interaction, it is determined whether the quality of the user assistance information satisfies said one or more targets.

8. The computer-implemented method according to claim 1, wherein the method furthermore comprises:
obtaining user feedback for the user assistance information,
wherein, on a basis of monitoring the user feedback, it is determined whether the quality of the user assistance information satisfies said one or more targets.

9. The computer-implemented method according to claim 1,
wherein the user assistance information comprises an operating indication for the graphical user interface.

10. The computer-implemented method according to claim 2,
wherein the ground truth for the user assistance information is at least partly different from the user assistance information.

11. The computer-implemented method according to claim 1,
wherein said one or more elements in the database comprise specified pairs of prompts and associated user assistance information.

12. The computer-implemented method according to claim 1,
wherein said one or more elements in the database comprise items of information, the items of information comprising:
a log file of the microscope;
a description of a current hardware configuration of the microscope;
a description of a current configuration of the graphical user interface;
an operating manual of the microscope;
an operating manual of the graphical user interface;
information about the user of the microscope and the graphical user interface; or
any combination thereof.

13. The computer-implemented method according to claim 1,
wherein the graphical user interface is provided by means of a first electronic data processing device,
wherein the inference of the machine-learned text model is triggered by means of a second electronic data processing device, which is encapsulated by the first electronic data processing device.

14. An electronic data processing device, comprising a processor and a memory, wherein the processor is designed to load program code from the memory and to execute the program code, wherein the processor executes a method according to claim 1 on a basis of executing the program code.
